(19) United States
(12) Patent Application Publication
(10) Pub. No.: US 2005/0177267 A1
(43) Pub. Date: Aug. 11, 2005

(54) Tank scheduling optimization for replicated chemical in a semiconductor manufacturing wet bench

(75) Inventors: Yu-Ling Chang, Hsinchu City (TW); Chen Chien Hsiung, Tainan County (TW); Hui-Tang Liu, Yong Kang City (TW)

Correspondence Address: HAYNES AND BOONE, LLP, 901 MAIN STREET, SUITE 3100, DALLAS, TX, 75202, US

(73) Assignee: Taiwan Semiconductor Manufacturing Co., Ltd., Hsin-Chu (TW)

(21) Appl. No.: 10/775,802

(22) Filed: Feb. 10, 2004

(51) Int. Cl. G06F 19/00

(52) U.S. Cl. 700/121; 700/89

(57) ABSTRACT

The present disclosure provides a system and method for identifying a tank containing a liquid from N number of tanks in a semiconductor manufacturing facility into which a batch of semiconductor products may be processed. An incoming batch of products to be processed in a predetermined number of tanks housing the liquid is received. A batch number associated with the batch is identified. A recipe index is determined using a relationship based on, for example, the modulus of N divided by the batch number, and a tank into which the batch is to be processed is determined using another relationship based at least in part on the recipe index and the predetermined number of tanks.

### BACKGROUND

The present disclosure relates generally to the field of semiconductor manufacturing and, more particularly, to a system and method for controlling and utilizing a plurality of tanks housing like liquids for the fabrication of semiconductor devices.

The semiconductor integrated circuit (IC) industry has experienced rapid growth. Technological advances in IC materials and design have produced generations of ICs where each generation has smaller and more complex circuits than the previous generation. However, these advances have increased the complexity of processing and manufacturing ICs and, for these advances to be realized, similar developments in IC processing and manufacturing have been needed. For example, an IC is formed by creating one or more devices (e.g., circuit components) on a substrate using a fabrication process. As the geometry of such devices is reduced to the submicron or deep submicron level, the IC's active device density (i.e., the number of devices per IC area) and functional density (i.e., the number of interconnected devices per IC area) has become limited by the fabrication process. Other complexities exist with respect to the scheduling and implementation of processes needed to produce semiconductor devices, as well as controlling the processes and the equipment used for those processes.

Accordingly, what is needed is an improved system and method for controlling and utilizing processing equipment such as tanks housing like liquids for the fabrication of semiconductor devices.

### BRIEF DESCRIPTION OF THE DRAWINGS

FIG. 1 depicts an exemplary tank scheduling optimization system for replicated liquids in a semiconductor manufacturing wet bench.

FIG. 2 depicts an exemplary virtual integrated circuit fabrication system in which the system of FIG. 1 may be implemented.

FIG. 3 depicts a more detailed example of the virtual integrated circuit fabrication system of FIG. 2.

FIG. 4 depicts an exemplary computer system that may be used in a virtual integrated circuit fabrication system such as described in FIGS. 2 and 3.

FIG. 5 is a diagram illustrating the movement of a product wafer and a monitor wafer with a semiconductor process tool.

FIG. 6 is a diagram illustrating the movement of a wafer batch with a semiconductor process tool.

FIG. 7 is a flow chart illustrating an embodiment of a method that may utilize the system of FIG. 1.

FIGS. 8a and 8b illustrate exemplary pseudocode methods that may be used in the method of FIG. 7 for identifying a target tank for recipes R having steps S.

FIG. 9 illustrates an exemplary pseudocode method that may be used in the method of FIG. 7 for identifying a target recipe for a batch B of products.

FIG. 10 illustrates another embodiment of a method for identifying a tank housing a liquid from N number of tanks.

### DETAILED DESCRIPTION

The present disclosure relates generally to the field of semiconductor manufacturing and, more particularly, to a system and method for controlling and utilizing a plurality of tanks housing like liquids (for example, tanks in a chemical wet bench) for the fabrication of semiconductor devices. It is understood, however, that the following disclosure provides many different embodiments, or examples, for implementing different features of the disclosure. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

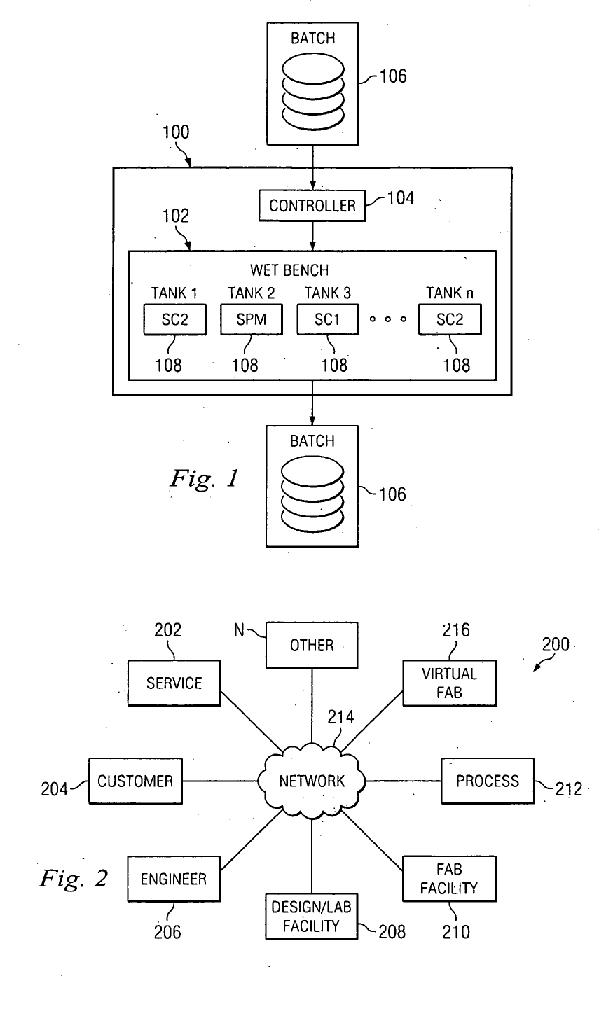

Referring to FIG. 1, an embodiment of a system 100 for scheduling the usage of like or replicated liquid housed in tanks in a semiconductor manufacturing facility for batches or lots of semiconductor products or wafers is shown. For the purposes of this disclosure, the terms “products,” “semiconductor products” and “wafers” are used interchangeably. In the present example, system 100 is configured to receive batches of semiconductor products 106 and includes wet bench 102 for processing semiconductor products and a controller 104. The wet bench may include process equipment used to etch or clean semiconductor wafers, including a series of tanks TANK1, TANK2, TANK3, . . . TANKn (collectively designated as tanks 108) configured to contain particular liquids or chemicals. Each tank 108 may have its own processing capability to handle variable kinds of wafers. The processing capability of some tanks may be the same, because, for example, they contain the same chemicals. Depending on different product types, wafers may or may not need to pass through each tank. Batches of wafers may follow a predefined processing time and processing sequence in a predefined recipe, wherein the wafers are loaded into a particular tank for a predetermined time. Then the wafers may be removed from this tank and placed into the next tank until the process is complete in accordance with the predefined recipe.

A batch of products 106 may include a substrate (with or without semiconductor devices) that is to be cleaned using one or more of a variety of chemical cleaners housed in a plurality of tanks. For example, the chemical cleaner may be a mixture of H₂SO₄ and H₂O₂ (commonly known as sulfuric peroxide mix (SPM)) that may be used for removing native oxides. Other exemplary chemical cleaners and cleaning methods include a mixture of ammonium hydroxide (NH₄OH), hydrogen peroxide (H₂O₂) and deionized (DI) water, commonly referred to as an “SC1 clean,” and a mixture of hydrochloric acid (HCl), hydrogen peroxide (H₂O₂), and deionized (DI) water, commonly referred to as an “SC2 clean.” Depending on the type of products being processed and the stage of the processing, each batch of products may be processed in one or more tanks containing like liquids or chemicals.

Using the controller 104, the system 100 detects the arrival of batches of semiconductor products to be processed in wet bench 102. The controller 104 identifies the appropriate predefined recipe indicating the processing sequence of a batch through tanks 108. The predefined recipe may be based, for example, on the batch number, the target liquid or chemical, the predetermined number of times the product is to be processed in the liquid, and/or a recipe number. Once the controller 104 defines the appropriate tanks in which the product should be processed, the products 106 are processed and then moved to the next fabrication process.

Referring now to FIG. 2, virtual IC fabrication system (“virtual fab”) 200 is one example of a system in which the tank scheduling system 100 of FIG. 1 may be used. The virtual fab 200 includes a plurality of entities 202, 204, 206, 208, 210, 212, . . . , N that are connected by a communications network 214. Network 214 may be a single network or may be a variety of different networks, such as an intranet and the Internet, and may include both wireline and wireless communication channels.

In virtual fab 200, the entity 202 represents a service system for service collaboration and provision, the entity 204 represents a customer, the entity 206 represents an engineer, the entity 208 represents a design/laboratory (lab) facility for IC design and testing, the entity 210 represents a fabrication (fab) facility, the entity 212 represents a process (e.g., an automated fabrication process), and the entity 216 represents another virtual fab (e.g., a virtual fab belonging to a subsidiary or a business partner). Each entity may interact with other entities and may provide services to and/or receive services from the other entities.

For purposes of illustration, each entity 202-212 and 216 may be referred to as an internal entity (e.g., the engineer 202 or the system process 212) that forms a portion of the virtual fab 200 or may be referred to as an external entity (e.g., the customer 204) that interacts with the virtual fab 200. Some entities may be both internal and external. For example, customer 204 may provide updated mask sets (internal) and may purchase the final products/services (external) also. It is understood that the entities 202-212 and 216 may be concentrated at a single location or may be distributed, and that some entities may be incorporated into other entities. In addition, each entity 202-212 and 216 may be associated with system identification information that allows access to information within the system to be controlled based upon authority levels associated with each entities identification information.

The virtual fab 200 enables interaction among the entities 202-212 and 216 for the purpose of IC manufacturing, as well as the provision of services. In the present example, IC manufacturing includes receiving a customer's IC order and the associated operations needed to produce the ordered ICs and send them to the customer 204, such as the design, fabrication, testing, and shipping of the ICs.

One of the services provided by the virtual fab 200 may enable collaboration and information access in such areas as design, engineering, and logistics. For example, in the design area, the customer 204 may be given access to information and tools related to the design of their product via the service system 202. The tools may enable the customer 204 to perform yield enhancement analyses, view layout information, and obtain similar information. In the engineering area, the engineer 206 may collaborate with other engineers using fabrication information regarding pilot yield runs, risk analysis, quality, and reliability. The logistics area may provide the customer 204 with fabrication status, testing results, order handling, and shipping dates. It is understood that these areas are exemplary, and that more or less information may be made available via the virtual fab 200 as desired.

Another service provided by the virtual fab 200 may integrate systems between facilities, such as between the design/lab facility 208 and the fab facility 210. Such integration enables facilities to coordinate their activities. For example, integrating the design/lab facility 208 and the fab facility 210 may enable design information to be incorporated more efficiently into the fabrication process, and may enable data from the fabrication process to be returned to the design/lab facility 200 for evaluation and incorporation into later versions of an IC. The process 212 may represent any process operating within the virtual fab 200.

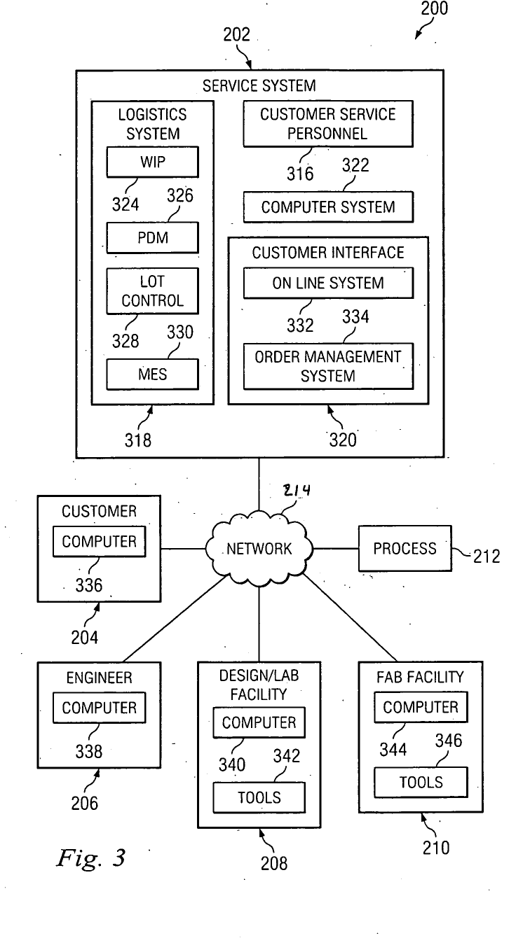

Referring now to FIG. 3, in another embodiment of the virtual fab 200, the entities 202-212 and 216 are described in greater detail. The service system 202 provides an interface between the customer and the IC manufacturing operations. For example, the service system 202 may include customer service personnel 316, a logistics system 318 for order handling and tracking, and a customer interface 320 for enabling a customer to directly access various aspects of an order.

The logistics system 318 may include a work-in-process (WIP) inventory system 324, a product data management system 326, a lot control system 328, and a manufacturing execution system (MES) 330. The WIP inventory system 324 may track working lots using a database. The product data management system 326 may manage product data and maintain product information in a product database. The product database could include product categories (e.g., part, part numbers, and associated information), as well as a set of process stages that are associated with each category of products. The lot control system 328 may convert a process stage to its corresponding process steps.

The MES 330 may be an integrated computer system representing the methods and tools used to accomplish production. In the present example, the primary functions of the MES 330 may include collecting data in real time, organizing and storing the data in a centralized database, work order management, workstation management, process management, inventory tracking, and document control. The MES 330 may be connected to other systems both within the service system 202 and outside of the service system 302. Examples of the MES 330 include Promis (Brooks Automation Inc. of Massachusetts), Workstream (Applied Materials, Inc. of California), Poseidon (IBM Corporation of New York), and Mirl-MES (Mechanical Industry Research Laboratories of Taiwan). Each MES may have a different application area. For example, Mirl-MES may be used in applications involving packaging, liquid crystal displays (LCDs), and printed circuit boards (PCBs), while Promis, Workstream, and Poseidon may be used for IC fabrication and thin film transistor LCD (TFT-LCD) applications. The MES 330 may include such information as a process step sequence for each product.

The customer interface 320 may include an online system 332 and an order management system 334. The online system 332 may function as an interface to communicate with the customer 204, other systems within the service system 202, supporting databases (not shown), and other entities 306-312. The order management system 334 may manage client orders and may be associated with a supporting database (not shown) to maintain client information and associated order information.

Portions of the service system 202, such as the customer interface 320 and data warehousing system 334 may be associated with a computer system 322. In some embodiments, the computer system 322 may include multiple computers, some of which may operate as servers to provide services to the customer 204 or other entities. The service system 202 may also provide such services as identification validation and access control, both to prevent unauthorized users from accessing data and to ensure that an authorized customer can access only their own data.

The customer 204 may obtain information about the manufacturing of its ICs via the virtual fab 300 using a computer system 336. In the present example, the customer 204 may access the various entities 202-212 and 216, of the virtual fab 200 through the customer interface 320 provided by the service system 202. However, in some situations, it may be desirable to enable the customer 204 to access other entities without going through the customer interface 320. For example, the customer 204 may directly access the fab facility 210 to obtain fabrication related data.

The engineer 206 may collaborate in the IC manufacturing process with other entities of the virtual fab 200 using a computer system 338. The virtual fab 200 enables the engineer 206 to collaborate with other engineers and the design/lab facility 208 in IC design and testing, to monitor fabrication processes at the fab facility 210, and to obtain information regarding test runs, yields, etc. In some embodiments, the engineer 206 may communicate directly with the customer 204 via the virtual fab 200 to address design issues and other concerns.

The design/lab facility 208 provides IC design and testing services that may be accessed by other entities via the virtual fab 200. The design/lab facility 208 may include a computer system 340 and various IC design and testing tools 342. The IC design and testing tools 342 may include both software and hardware.

The fab facility 210 enables the fabrication of ICs. Control of various aspects of the fabrication process, as well as data collected during the fabrication process, may be accessed via the virtual fab 200. The fab facility 210 may include a computer system 344 and various fabrication hardware and software tools and equipment 346. For example, the fab facility 210 may include wet bench 102, an ion implantation tool, a chemical vapor deposition tool, a thermal oxidation tool, a sputtering tool, and various optical imaging systems, as well as the software needed to control these components.

The process 212 may represent any process or operation that occurs within the virtual fab 200. For example, the process 212 may be an order process that receives an IC order from the customer 204 via the service system 202, a fabrication process that runs within the fab facility 210, a design process executed by the engineer 206 using the design/lab facility 208, or a communications protocol that facilities communications between the various entities 202-212.

It is understood that the entities 202-212 and 216 of the virtual fab 200, as well as their described interconnections, are for purposes of illustration only. For example, it is envisioned that more or fewer entities, both internal and external, may exist within the virtual fab 300, and that some entities may be incorporated into other entities or distributed. For example, the service system 202 may be distributed among the various entities 206-210.

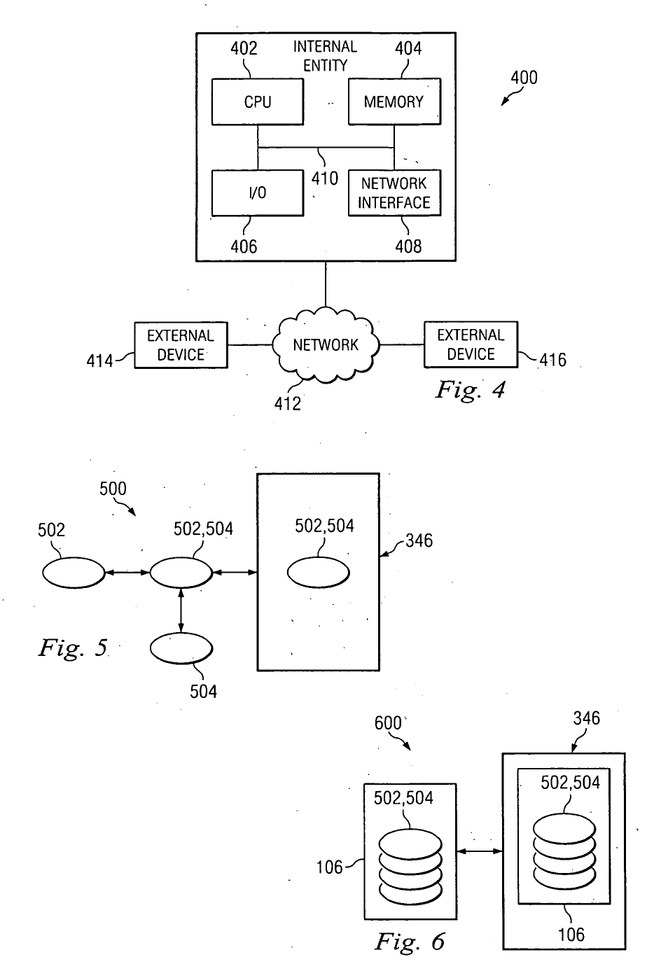

Referring now to FIG. 4, an exemplary computer 400 may be used to implement one or more portions of the embodiments, including the implementation of a system and method for controlling and utilizing a plurality of tanks in a chemical wet bench for the fabrication of semiconductor devices in virtual fab 200. The computer 400 may include a central processing unit (CPU) 402, a memory unit 404, an input/output (I/O) device 406, and a network interface 408. The network interface may be, for example, one or more network interface cards (NICs). The components 402, 404, 406, and 408 are interconnected by a bus system 410. It is understood that the computer may be differently configured and that each of the listed components may actually represent several different components. For example, the CPU 402 may actually represent a multi-processor or a distributed processing system; the memory unit 404 may include different levels of cache memory, main memory, hard disks, and remote storage locations; and the I/O device 406 may include monitors, keyboards, and the like.

The computer 400 may be connected to a network 412, which may be connected to the networks 214 (FIGS. 2, 3). The network 412 may be, for example, a complete network or a subnet of a local area network, a company wide intranet, and/or the Internet. The computer 400 may be identified on the network 412 by an address or a combination of addresses, such as a media control access (MAC) address associated with the network interface 408 and an internet protocol (IP) address. Because the computer 400 may be connected to the network 412, certain components may, at times, be shared with other devices 414, 416. Therefore, a wide range of flexibility is anticipated in the configuration of the computer. Furthermore, it is understood that, in some implementations, the computer 400 may act as a server to other devices 414, 416. The devices 414, 416 may be computers, personal data assistants, wired or cellular telephones, or any other device able to communicate with the computer 400.

Referring now to FIG. 5, an environment 500 that may exist within the virtual fab of FIGS. 2 and 3 includes a semiconductor process tool 346 (such as the process tool 346 of FIG. 3) associated with the movement of a product wafer 502 and a monitor wafer 504. In a semiconductor manufacturing environment, the startup of a new process and/or equipment may include a significant amount of manual testing and optimizing of the process by an operator. After testing and optimizing the process, the process tool 346 may be qualified for processing the product wafer(s) 502. In some semiconductor manufacturing processes, periodic testing of the process and/or the process tool 346 may be performed. Such testing may include placing the monitor wafer 504 into the process tool 346 with or without processing. The monitor wafer 504 may be a blank substrate or a substrate including a plurality of semiconductor devices. The process tool 346 may be a single or multiple process tool such as a cluster tool. The process tool 346 may further include a chemical bench or any other tool that may be employed for etching, photolithography, diffusion, thin film deposition, or other manufacturing operations. In the case of etching, the process tool 346 may be a chemical bench or bath or a dry process, wherein the environment may be dry and employ processes such as plasma or vapor etching.

Referring now to FIG. 6, an environment 600 provides for the movement of a wafer batch (e.g., lot), such as the wafer batch 106 of FIG. 1, through the semiconductor process tool 346 of FIG. 5. When wafer batch 106 enters process tool 346, either the entire wafer batch 106 or a single wafer from the batch may be processed. The wafer batch 106 may include a single wafer or a plurality of wafers. Wafer batch 106 may include monitor wafer(s) 504, product wafer(s) 502, or both, as described in FIG. 5. Each wafer may include one or more semiconductor devices or no semiconductor devices. In some embodiments, wafer batch 106 may be encased in a container that may be purged with a dry inert gas such as N₂, Ar, He, or another fluid.

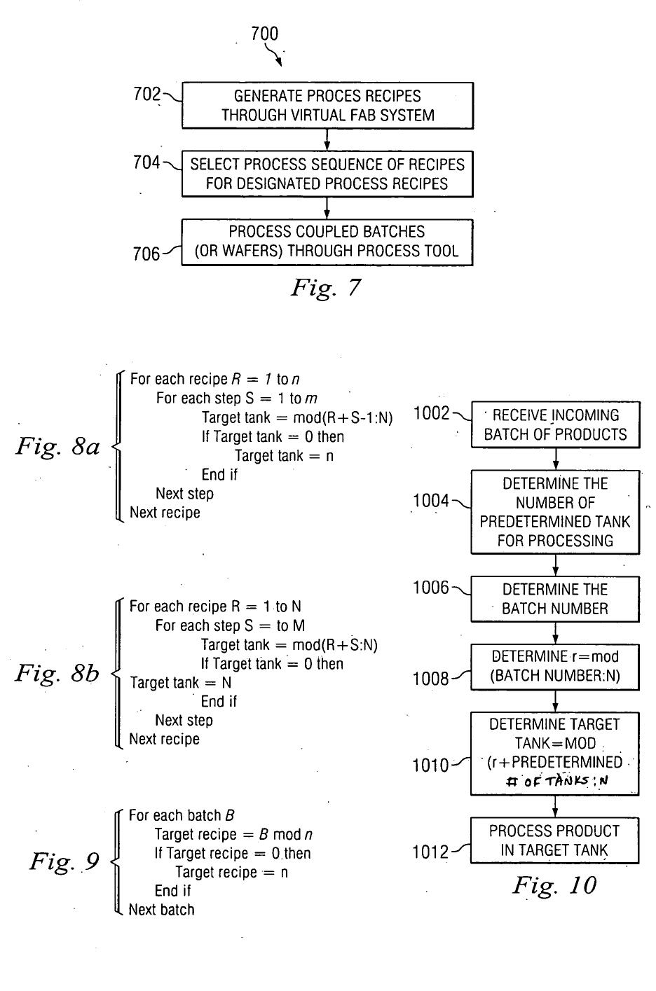

Referring now to FIG. 7, a method 700 illustrates one embodiment of a method for controlling and utilizing a plurality of tanks in a chemical wet bench for the fabrication of semiconductor devices. The method 700 may be utilized by a process tool (such as the process tool 346 previously described) and may be maintained and controlled through a virtual fab system (such as the virtual fab system 200 of FIG. 2). In step 702, the virtual fab system 200 may utilize a recipe generator to generate process recipes associated with incoming batches of wafers to be processed. The process recipes may include a plurality of instructions and parameters for setting the conditions of the process and process tool 346. The instructions and parameters may include chemical concentration, chemical solution type, chemical temperature, and process time in the case of a chemical etch process tool, as well as other parameters. For example, other parameters may include gas flow rates, pressure, temperature, RF input power, backside cooling flow, process time, and other process parameters and steps. The recipes may include a plurality of process recipes, which may include not only instructions for a process and process tool 346, and may further include sequences for data collection and input through the virtual fab system 200.

In some embodiments, step 702 may include a method for optimizing the capacity of the process tool 346. This optimization may enable the utilization of all tanks of the process tool 346, or may at least minimize the number of tanks not being used. For example, in a chemical etch process tool, the method for optimizing the process capacity may include designating a process recipe and a plurality of recipe steps in such a way that the tanks are used in a relatively efficient manner in terms of capacity.

In one embodiment, the number of recipes created may be equal to the number of tanks holding like or replicated chemicals in the wet bench. Each recipe may include the specific tanks to be utilized in the process, with no recipes specifying the same tanks at the same time. An example tank sequence component of recipes for “n” tanks (and “n” recipes), having “n” number of steps in a recipe is as follows:
Recipe 0
T₀ [symbol] T₁ [symbol] T₂ . . . Tₙ₋₃ [symbol] Tₙ₋₂ [symbol] Tₙ₋₁
Recipe 1
T₁ [symbol] T₂ [symbol] T₃ . . . Tₙ₋₂ [symbol] Tₙ₋₁ [symbol] T₀
Recipe 2
T₂ [symbol] T₃ [symbol] T₄ . . . Tₙ₋₁ [symbol] T₀ [symbol] T₁
.
.
Recipe n−1
Tₙ₋₁ [symbol] T₀ [symbol] T₁ . . . Tₙ₋₄ [symbol] Tₙ₋₃ [symbol] Tₙ₋₂

More specifically, the following three examples each show three exemplary recipes for 3 tanks (T0, T1 and T2) containing the same chemical when each batch of products 106 needs to be processed in only one tank (Example 1), in two tanks (Example 2), or in three tanks (Example 3):

### EXAMPLE 1

Recipe 0: T₀
Recipe 1: T₁
Recipe 2: T₂

### EXAMPLE 2

Recipe 0: T₀ [symbol] T₁
Recipe 1: T₁ [symbol] T₂
Recipe 2: T₂ [symbol] T₀

### EXAMPLE 3

Recipe 0: T₀ [symbol] T₁ [symbol] T₂
Recipe 1: T₁ [symbol] T₂ [symbol] T₀
Recipe 2: T₂ [symbol] T₀ [symbol] T₁

The recipes may be generated by numerous mechanisms, including by hand or automatically. In one embodiment, a method for generating target tanks from the N number of tanks for each step S in each recipe R may be utilized, where steps S represents the number of tanks into which the product is processed per recipe. In such an embodiment, the target tanks for each step of the process may be generated using one of the following relationships:
Target Tank=MOD (S+R−1:N) or Target Tank=MOD (S+R:N)
wherein the MOD or modulus returns the remainder when one number (N) is divided by another (S+R−1 or S+R). Exemplary pseudocode illustrating methods for implementing these relationships is shown in FIGS. 8a and 8b, respectively. It is understood that other recipe generators may be used to generate the recipes so long as no two recipes contain the same tank selection.

The recipes may be generated and stored prior to the processing of the product through the process tool 346. For example, these recipes or similar ones associated with a certain product may be generated and stored anywhere in the virtual fab 200, provided they are accessible to aid in the processing of the products. The recipes may be preprogrammed into a storage unit or memory unit 404 (FIG. 4) in any accessible location (for example, in a look-up table), including in process tool 346 or in computer 344 of fab facility 210. In addition or alternatively, recipes for the identification of the tanks to be used in a processing step may be generated during the processing of the products.

In step 704, a recipe with a process sequence may be designated for a particular batch utilizing a recipe-to-batch generator. The sequence may include a plurality of process recipes which may include not only instructions for a process and process tool 346, but also for data collection and input through the virtual fab system 200. In one implementation of a recipe-to-batch generator, once the batch number B associated with the product to be processed is identified, then a target recipe number R may be determined from the following relationship:
Target Recipe R=MOD(B:N)
wherein the MOD or modulus returns the remainder when one number (N) is divided by another (B). The batch number B may be any number or symbol representing a relative number of batches, products, or wafers being processed through the tanks. For example, the batch number B may be associated with the total number of batches that have been processed through the tanks since the replacement of the liquid in the tank, the total number of batches processed on a specific date, etc. Exemplary pseudocode representing a method for implementing this relationship is shown in FIG. 9.

In step 706, once the recipe R is determined for batch B, then the product may be processed through process tool 346. Operation of the process tool 346 may occur in parallel with steps 702 and 704, which may be executed for new batch(s) 106 and product wafer(s) 502 (e.g., multiple batches may be processed at the same time using the method 700 as long as there is only one batch per tank).

Referring now to FIG. 10, another embodiment of a method for identifying a tank housing a liquid from N number of tanks is disclosed. In step 1002, a process tool 346 (FIG. 3) receives an incoming batch of products. The process tool 346 is configured to identify a predetermined number of tanks housing the liquid into which the products will be processed in step 1004. In step 1006, the batch number associated with the batch is determined. The batch number may be any number or symbol representing a relative number of batches, products, or wafers being processed through the tanks. For example, the batch number may be associated with the total number of batches that have been processed through the tanks since the replacement of the liquid in the tank, the total number of batches processed on a specific date, etc. In step 1008, a recipe is determined using the relationship:
Target Recipe R=MOD(batch number:N).
In step 1010, a target tank is identified using one of the following relationships:
Target Tank=MOD(predetermined number of tank+recipe index-1:N) or
Target Tank=MOD(predetermined number of tank+recipe index:N).
The product may then be processed in the target tank in step 1012.

The present disclosure has been described relative to a preferred embodiment. Improvements or modifications that become apparent to persons of ordinary skill in the art only after reading this disclosure are deemed within the spirit and scope of the application. It is understood that several modifications, changes and substitutions are intended in the foregoing disclosure and in some instances some features of the disclosure will be employed without a corresponding use of other features. For example, it is understood that other relationships may be used to achieve similar optimizations. Furthermore, the relationships may be used in other processing areas and/or with other processes, including processes that use gases. Accordingly, it is appropriate that the appended claims be construed broadly and in a manner consistent with the scope of the disclosure.

1. A method for identifying a tank containing a liquid from N number of tanks in a semiconductor manufacturing facility into which a batch of semiconductor products is to be processed, the method comprising:
receiving an incoming batch of products to be processed in a predetermined number of tanks housing the liquid;
identifying a batch number of the batch;
determining a recipe index from a modulus of N divided by the batch number; and
determining the tank into which the batch is to be processed from the modulus of the sum of the recipe index and the predetermined number of tanks, divided by N.

2. The method of claim 1, wherein the batch number associated with the batch to be processed is representative of the number of batches that have been processed in the liquid in the tanks since the last time the liquid was changed.

3. The method of claim 1, additionally comprising processing the incoming products in the tank identified.

4. A method for identifying a tank housing a liquid from N number of tanks in a semiconductor manufacturing facility into which a batch of semiconductor products from a number of batches is to be processed, the method comprising:
generating R tank running sequence recipes each having S steps, wherein the total number of R recipes is N and a T tank is associated with each S step in each R recipe wherein T is modulus of the sum of R and S, divided by N;
receiving an incoming batch of products to be processed in the liquid;
identifying a number B of the batch associated with the products; and
determining the T tanks into which the batch is to be processed by identifying the R recipe associated with batch B by the modulus of N divided by B.

5. The method of claim 4, wherein N equals 3.

6. The method of claim 5, wherein S equals 1 and each recipe identifies one tank, wherein no recipe has the same two tanks identified.

7. The method of claim 5, wherein S equals 2 and each recipe identifies two tanks, wherein no recipe has the same two tanks identified.

8. The method of claim 5, wherein S equals 3 and each recipe identifies three tanks, wherein no recipe has the same three tanks identified.

9. The method of claim 4, additionally comprising assigning each of the N recipes to each of the B batches in a look-up table.

10. The method of claim 4, additionally comprising processing the incoming products in the tanks identified.

11. A method for scheduling the usage of liquid housed in N number of tanks in a semiconductor manufacturing facility for batches of semiconductor products, the method comprising:
generating R tank running sequence recipes each having S steps, wherein the total number of R recipes is N and a T tank is associated with each S step in each R recipe wherein T is modulus of the sum of R and S, divided by N;
assigning each recipe R to at least one batch number B, wherein the R recipe for each batch number B is the modulus of N divided by B; and
storing the recipes and associated batch numbers.

12. The method of claim 11, additionally comprising receiving an incoming batch of products to be processed in the liquid;
identifying a number B of the batch associated with the products; and
retrieving the stored recipe associated with batch number B.

13. The method of claim 12, additionally comprising processing the incoming products in the tanks identified.

14. The method of claim 11, wherein R ranges from 0 to N−1 and R is an integer.

15. The method of claim 11, wherein R ranges from 1 to N and R is an integer.

16. The method of claim 11, wherein S ranges from 0 to 2 and for each S, no recipe has the same tanks identified.

17. A system for identifying a tank housing a liquid from N number of tanks in a semiconductor manufacturing facility into which a batch of semiconductor products is to be processed in a predetermined number of tanks housing the liquid, the system comprising:
N number of tanks housing the liquid; and
a controller adapted for identifying a batch number of the batch of products, determining a recipe number from the modulus of N divided by the batch number, and determining the tank into which the batch is to be processed from the modulus of the sum of the recipe number and the predetermined number of tanks, divided by N.

18. The system of claim 17, additionally comprising a device configured to process the incoming products in the tank identified.

19. A system for scheduling the usage of liquid housed in N number of tanks in a semiconductor manufacturing facility for batches of semiconductor products, the system comprising:
a recipe generator configured to identify the number of tanks N and the number of tanks per batch into which the products is to be processed and generate R recipes having S steps in each, wherein a T tank is associated with each S step in each R recipe, wherein T is modulus of the sum of R and S, divided by N, and wherein the total number of recipes is N.
a recipe-to-batch generator accessible to the recipe generator and configured to assign each recipe R to at least one batch number B, wherein the R recipe for each batch number B is the modulus of N divided by B; and
a memory accessible to the recipe generator and the recipe-to-batch generator to store the recipes and associated batch numbers.

20. The system of claim 19, additionally comprising
N number of tanks housing the liquid;
a batch identification device configured to receive an incoming batch of products to be processed in the liquid and identify a batch number B of the batch of products; and
a controller in communication with the batch identification device and the memory, wherein the controller is adapted to retrieve a stored recipe associated with batch number B.

21. A system for identifying a tank housing a liquid from N number of tanks in a semiconductor manufacturing facility into which a batch of semiconductor products is to be processed in a predetermined number of tanks housing the liquid, the system comprising:
N number of tanks housing the liquid;
means for receiving a batch of products and identifying a batch number of the batch of products;
means for determining a recipe number from a modulus of N divided by the batch number;
means for determining the tank into which the batch is to be processed from a modulus of the sum of the recipe number and the predetermined number of tanks, divided by N; and
means for processing the incoming products in the tank identified.
